(19) United States
(12) Patent Application Publication
(10) Pub. No.: US 2012/0045339 A1
(43) Pub. Date: Feb. 23, 2012

(54) ROTOR BLADES

(76) Inventors: Angus Fleming, Berkshire (GB); Mathew Dawson, Gloucestershire (GB); James Stewart, Berkshire (GB); Lucy Sun, Berkshire (GB); Jon Hossell, Berkshire (GB)

(21) Appl. No.: 13/139,056

(22) PCT Filed: Dec. 12, 2009
(86) PCT No.: PCT/GB09/02870

§ 371 Date: Aug. 3, 2011

(30) Foreign Application Priority Data
Dec. 12, 2008 (GB) 0822681.3

(51) Int. Cl. F03B 3/12; F03B 11/00; F03B 3/04

(52) U.S. Cl. 416/212 R; 416/213 R; 416/248; 416/204 R

(57) ABSTRACT

A rotor blade comprises a blade portion, a root portion (30) connected with, and extending from, the blade portion, the root portion (30) having an annular cross section which defines first and second root surfaces, and a plurality of discrete root fittings (31) connected with respective portions of the root portion (30), and adapted for attachment to a blade mounting. Each root fitting comprises an elongate body member (31) which extends from a free end of the root portion (30) towards the blade portion, which defines first and second bonding surfaces, adhesively bonded to the first and second root surfaces respectively, and which includes means for attachment to a blade mounting.

The present invention relates to rotor blades, and, in particular, to rotor blades for use in underwater tidal power generation installations.

### BACKGROUND OF THE INVENTION

There is increasing interest in the use of underwater power generating equipment that makes use of the energy of tidal flows. Such equipment is secured to the bed of a body of water, such as a sea, estuary or river, and makes use of a rotary generator to generate electricity. The generator is driven by a number of rotor blades placed in the water flow. An example of such a tidal power generating installation is illustrated in FIG. 1 of the accompanying drawings.

In the example shown in FIG. 1 of the accompanying drawings, the installation 1 is located on a bed 2 of a body of water 3. A generating unit 4 is mounted on an underwater support structure 5 which is fixed to the bed 2. The generating unit 4 includes a rotary generator and associated equipment for generating electricity. The generator is driven by a rotor 6 carried on an input shaft of the generator. The rotor 6 has a plurality of rotor blades 14.

FIGS. 2 and 3 of the accompanying drawings illustrate respective cross sectional views of a rotor blade 14 which comprises a root 16 by which the rotor blade is attached to the rotor of the generator. The blade is attached to the rotor using a root fitting 17. A spar 20 extends from the root 16 to a tip 18 of the blade. The blade has a leading edge 22 and a trailing edge 24, and the shape of the blade is defined by first and second skins 26 and 28. The skins 26 and 28 are generally of a composite fibre/resin material, and are moulded to the correct shape. The skins 26 and 28 are supported by the spar 20 which provides the blade 14 with additional strength.

FIG. 4 of the accompanying drawings illustrates a known root fitting 17 for a rotor blade. The root fitting 17 is a single cast metallic part having a flange portion 171, through which a series of holes 172 extend. The holes 172 are for receiving bolts for attaching the root fitting to a blade mounting. A blade fitting portion 173 extends from the flange portion 171, and is shaped to engage with a root portion of the blade itself, as illustrated in the previous drawings.

Rotor blades for underwater use generate large bending moments about the root fitting 17, and so this component must be large in order to be able to carry the large loads placed upon it. As shown in FIG. 4, the fitting is typically a single metallic casting. Such existing root fitting components have several disadvantages. Firstly, the component is very heavy and cumbersome, which limits the number fabricators that are able to produce such a part, and the process of fitting the blade to the root fitting is complex and requires specialist heavy lifting equipment. Secondly, the root fitting must be of the highest quality in order that it does not fail under the high loads. As such, even the smallest fault in the casting, machining, and finishing processes would result in the scrapping of the entire root fitting.

It is, therefore, desirable to provide a root fitting for a rotor blade that can overcome the disadvantages of the known root fittings.

### SUMMARY OF THE INVENTION

According to one aspect of the present invention, there is provided a rotor blade comprising a blade portion, a root portion connected with, and extending from, the blade portion, the root portion having an annular cross section which defines first and second root surfaces, and a plurality of discrete root fittings connected with respective portions of the root portion and adapted for attachment to a blade mounting, wherein each root fitting comprises an elongate body member which extends from a free end of the root portion towards the blade portion, which defines first and second bonding surfaces, adhesively bonded to the first and second root surfaces respectively, and which includes means for attachment to a blade mounting.

According to another aspect of the present invention, there is provided a rotor blade comprising a blade portion, a root portion connected with, and extending from, the blade portion, the root portion defining first and second root surfaces, the first root surface being an outer surface of the root portion, and the second root surface being an inner surface of the root portion that bounds an interior volume thereof, and a plurality of discrete root fittings connected with respective parts of the root portion of the blade, each root fitting comprising an attachment portion adapted for attachment to a blade mounting, and an elongate body member defining first and second bonding surfaces, which elongate body member extends from a free end of the root portion towards the blade portion, such that the first bonding surface extends adjacent the first surface of the root portion, and such that the second bonding surface extends adjacent the second root surface of the root portion, the first and second bonding surfaces being adhesively bonded to the first and second root surfaces respectively.

The first and second root surfaces may be substantially parallel to one another.

Alternatively, portions of the first and second root surfaces may converge towards the end of the root portion.

In one example, the first bonding surface is substantially parallel to the first root surface and the second bonding surface is substantially parallel to the second root surface.

Portions of the first and second root surfaces may diverge towards an end region of the root portion.

Each root fitting may be bolted to the root portion of the blade. In such an example, each root fitting may further comprise a bolt which extends through the body portion of the root fitting and through the root portion of blade.

The first and second root surfaces and the first and second bonding surfaces may be substantially smooth. Alternatively, at least one of the first and second root surfaces and the first and second bonding surfaces may be treated to increase bonding strength of an adhesive bonding medium.

In one embodiment, the root fittings are arranged as a series around the root portion of the blade, each root fitting being interlocked with the next root fitting in the series.

The body member may comprise separate first and second body portions which define the first and second bonding surfaces respectively.

In such an example, the root portion may have a third root surface which extends between the first and second root surfaces, and the first body portion may include an end part which has an inner surface extending substantially parallel to, and adjacent, the third surface, and an outer surface, and the second body portion may includes an end part which has an inner end surface extending parallel to, and adjacent, the outer surface of the first body portion. In such an example, the end part of the first body portion may define a threaded hole for reception of a threaded stud therein, the threaded hole having an axis extending away from the root portion, and the end part of the second body portion may define a hole coaxial with the threaded hole, such that a threaded stud received in the threaded hole extends from the end part of the first body portion, through the end part of the second body portion, in a direction away from the root portion of the blade.

One embodiment may further comprise a threaded component located between respective end regions of the first and second body portions.

The first and second body portions may have respective end regions, each end region defining at least one receiving feature, and the root fittings may be arranged around the root portion of the blade to form a series, such that receiving features of neighbouring root fittings define at least one attachment aperture, the blade may further comprise a plurality of fixing components located in respective attachment apertures, the fixing components having features for enabling attachment of the blade to a rotor.

\the first and second body portions may have respective end regions, which define a receiving aperture therebetween, and the blade may comprise a plurality of threaded components, located in respective receiving apertures.

The first and second body portions may have respective end regions which interengage with one another.

The root fittings may be arranged as a series around the root portion of the blade, each root fitting being interlocked with the next root fitting in the series.

In such an example, the second body portion of each root fitting may engage with the first body portion of that fitting, and with the first body portion of the next root fitting in the series. According to another aspect of the present invention, there is provided a root fitting means for attaching a rotor blade to a blade mounting, which rotor blade comprises a blade portion, and a root portion connected with, and extending from, the blade portion, the root portion having an annular cross section which defines first and second root surfaces, the root fitting means comprising a plurality of discrete root fittings adapted for connection with respective portions of the root portion of the rotor blade, and for attachment to a blade mounting, wherein each root fitting comprises an elongate body member which extends from a free end region towards a blade end region, which defines first and second bonding surfaces, adapted to be adhesively bonded to first and second root surfaces respectively of a rotor blade, and which includes means for attachment to a blade mounting.

The first and second bonding surfaces may be substantially parallel to one another. Alternatively, portions of the first and second bonding surfaces may converge towards the free end region. Alternatively, portions of the first and second bonding surfaces may diverge towards the free end region.

A root fitting embodying the present invention may be adapted to be bolted to the root portion of the blade.

The first and second bonding surfaces may be substantially smooth. Alternatively, at least one of the first and second bonding surfaces may be treated to increase bonding strength of an adhesive bonding medium.

The body member may comprise separate first and second body portions which define the first and second bonding surfaces respectively.

The first body portion may include an end part which has an inner surface, and an outer surface, and wherein the second body portion may include an end part which has an inner end surface extending parallel to, and adjacent, the outer surface of the first body portion. The end part of the first body portion may define a threaded hole for reception of a threaded stud therein, the threaded hole having an axis extending away from the root portion, and wherein the end part of the second body portion may define a hole coaxial with the threaded hole, such that a threaded stud received in the threaded hole extends from the end part of the first body portion, through the end part of the second body portion, in a direction away from the root portion of the blade.

The end part of the first body portion may define a hole having an axis extending away from the root portion, and the end part of the second body portion may define a hole coaxial with the hole through the first body portion, thereby allowing a fixing arrangement to extend through the first and second body portions of the elongate body member.

A root fitting means embodying an aspect of the present invention may further comprise a threaded component located between respective end regions of the first and second body portions.

The first and second body portions may have respective end regions, each end region defining at least one receiving feature, such that when the root fittings are arranged around the root portion of the blade to form a series, receiving features of neighbouring root fittings define at least one attachment aperture in which a fixing component is located, the fixing components having features for enabling attachment of the blade to a rotor.

The first and second body portions may have respective end regions, which define a receiving aperture therebetween, in which aperture an attachment component is located. The first and second body portions may have respective end regions which interengage with one another.

### BRIEF DESCRIPTION OF THE DRAWINGS

FIG. 1 illustrates an underwater tidal power generation installation;

FIG. 2 illustrates a first cross sectional view of a rotor blade for use in the installation of FIG. 1;

FIG. 3 illustrates a second cross sectional view of the blade of FIG. 2;

FIG. 4 illustrates a previously considered root fitting for a rotor blade;

FIG. 5 illustrates principles of a root fitting embodying the present invention;

FIGS. 6 to 22 illustrate respective embodiments of the present invention;

FIGS. 22 to 25 illustrate respective features applicable to embodiments of the present invention; and

FIG. 26 illustrates a further embodiment of the present invention.

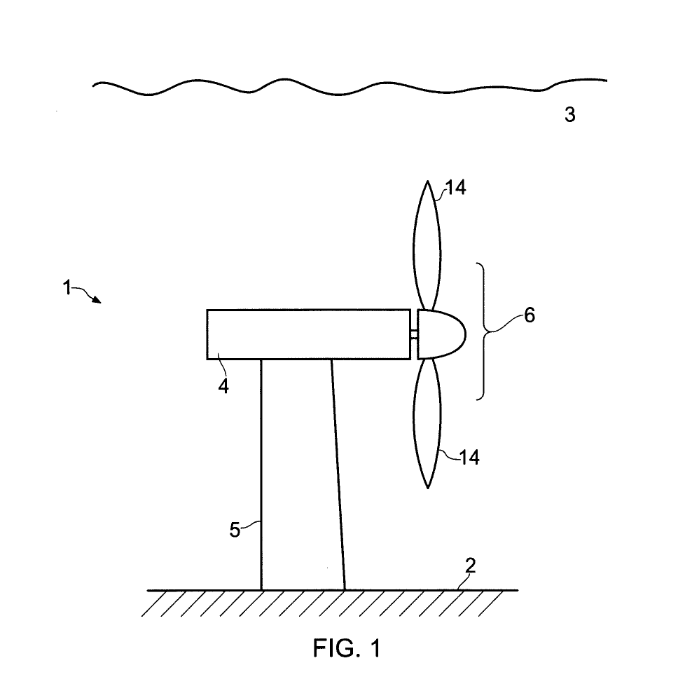

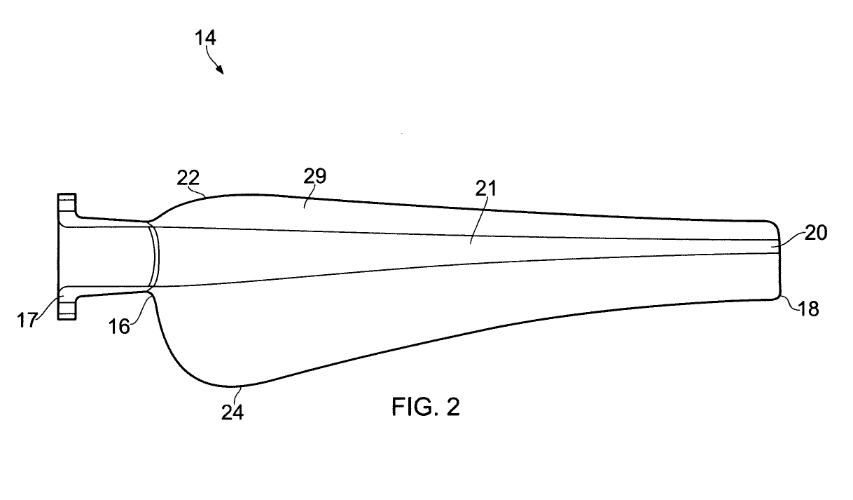

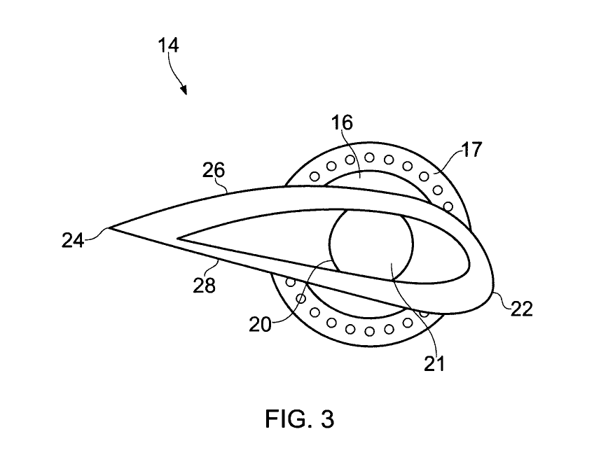

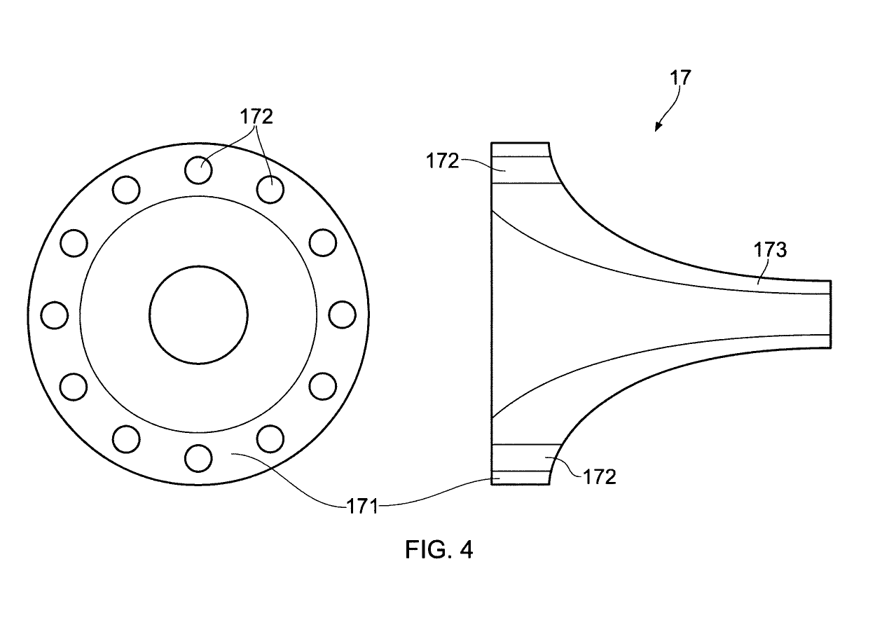

### DETAILED DESCRIPTION OF THE PREFERRED EMBODIMENTS

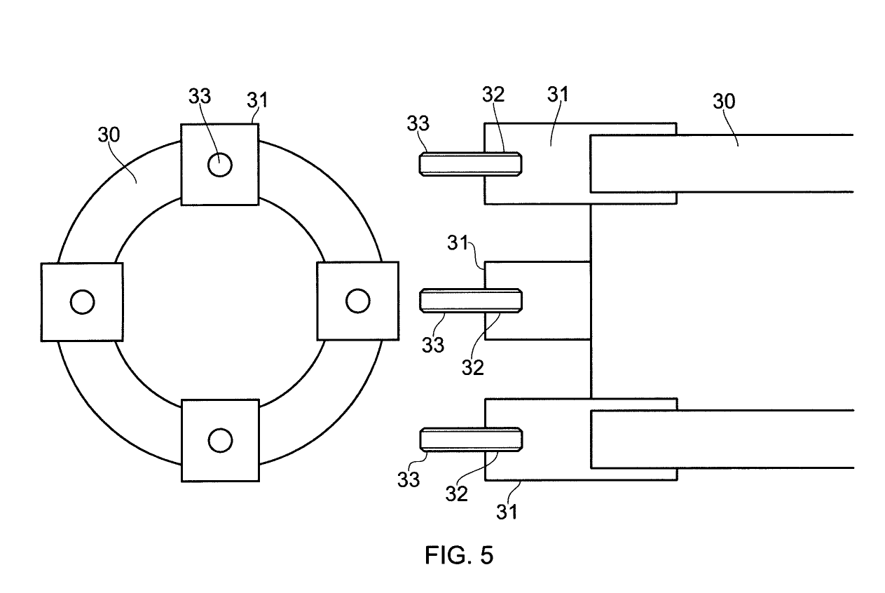

FIG. 5 shows a cross sectional side view, and an end view of a rotor blade root and root fitting, and illustrates the principles underlying root fittings embodying the present invention. As described above a rotor blade comprises a blade portion and a root portion which extends from the blade portion. The root portion may be provided by an end region of a spar of the blade, which spar extends along the length of the blade, as is well known in blade design. Embodiments of the present invention are concerned with the design of root fitting which enables the blade to be attached to a blade mounting. In the following examples, the root portion of the blade is provided by a free end of the spar 30 of the rotor blade, but could be provided by any suitable part of the blade.

In the example shown in FIG. 5, the root portion 30 is annular in cross section. Alternatively, the root portion 30 could be of any tubular cross section, such as ovoid, square or rectangular, depending upon design considerations. A root fitting technique embodying the principles of the present invention comprises a plurality of discrete fittings 31, which are connected at respective positions with the root portion 30. For the sake of clarity, only four root fittings are illustrated in FIG. 5. It will be readily appreciated that a root fitting technique embodying the present invention can have any number of root fittings, and that, in practice, the number is likely to far exceed four. The precise number of fittings provided, however, does not affect the underlying principles of the present invention. Each root fitting 31 is bonded onto the end of the spar 30, and is provided with means 32, 33 for attachment to a blade mounting (not shown for clarity). One example of such attachment means is a threaded hole 32, and corresponding threaded stud 33, the stud extending away from the root portion 30.

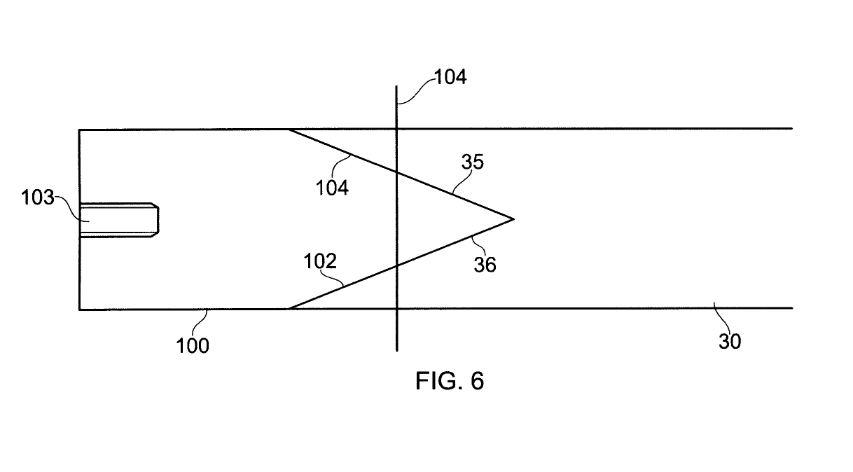

In the following, only a single root fitting 31 is shown and described, only for the sake of clarity. It is to be understood that a plurality of such root fittings would be used in practice. A first embodiment of the present invention is shown in FIG. 6. In this example, the root portion 30 of the blade defines first and second root surfaces 35 and 36. In this embodiment, the root surfaces 35 and 36 extend into the root portion, and converge, thereby forming a hollow V-shaped region. The root fitting 31 is provided by a body 100, which could be a cast metallic part. The body 100 is shaped so as to fit into the V-shaped region of the root portion, and has first and second bonding surfaces 101 and 102, which engage with the first and second root surfaces 35 and 36 respectively. The root portion 30 and the body 100 are held together by applying an adhesive medium to the root and bonding surfaces, such that those surfaces are bonded together. The root portion 30 and the body 100 may also be attached to one another using a bolt 104 in addition to the adhesive medium. The body 100 may be provided with a threaded hole 103 for receiving a threaded stud (not shown), for attachment to a blade mounting. Any suitable alternative fitting may be provided. The plurality of fittings is arranged around the end of the root portion 30, so as to provide a plurality of attachment means (the threaded studs) for the rotor blade.

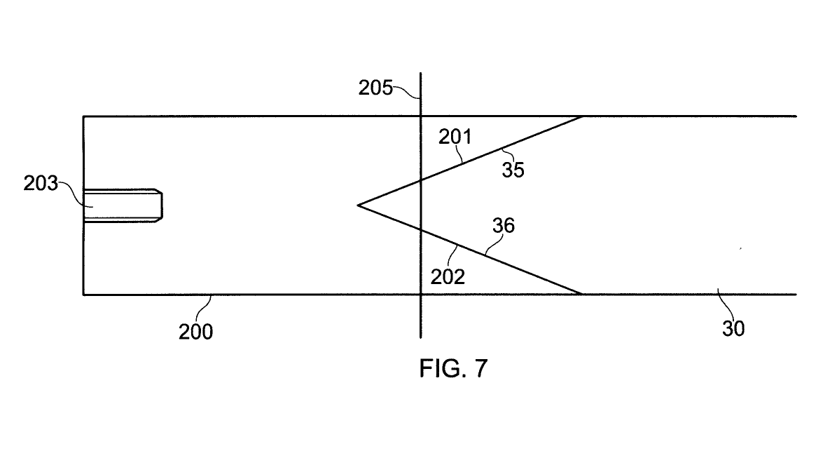

FIG. 7 illustrates a second embodiment of the present invention. As before, the spar of the rotor blade provides the root portion 30 to which the root fittings are connected. In the embodiment of FIG. 7, the root portion 30 tapers at its end, and has first and second root surfaces 35 and 36 that converge. A body 200, which may be a cast metallic part, has first and second bonding surfaces 201 and 202 that are arranged to engage with the first and second root surfaces 35 and 36 respectively. The first bonding surface 201 is substantially parallel to the first root surface 35, and the second bonding surface 202 is substantially parallel to the second root surface 36. The body 200 is attached to the root portion 30 by the provision of an adhesive medium on the junction between the first and second root and bonding surfaces 35 and 201, 36 and 202. In addition, one or more bolts 205 may be provided that extends through the body 200 and the root portion 30. The bolt 205 serves to hold the adhesive medium in compression between the surfaces of the root portion and the body, and also serves to prevent splitting of that joint. The body 200 is provided with a threaded hole 203 for receiving a threaded stud (not shown) for attachment to a blade mounting.

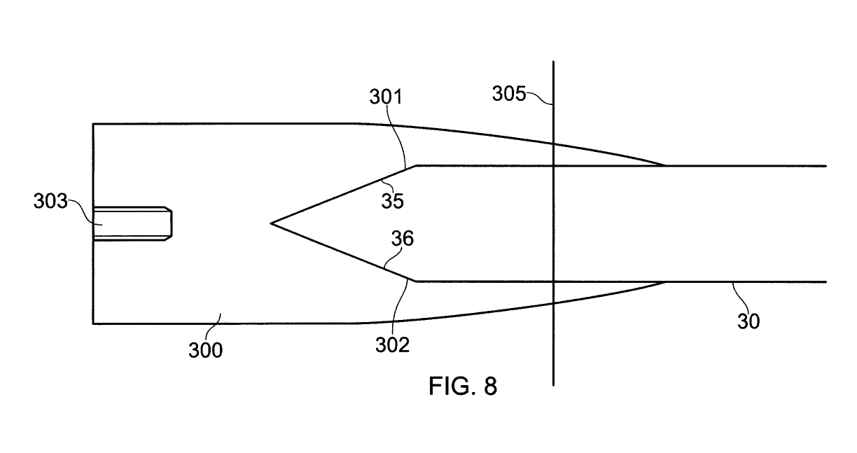

FIG. 8 shows a third embodiment of the present invention, which is similar to the second embodiment described with reference to FIG. 7. In this third example, the root portion has first and second root surfaces 35 and 36 which have portions that taper towards one another. The fitting has a body 300, which has bonding surfaces 301 and 302 that are substantially parallel to, and engage with, the root surfaces 35 and 36. In this third example, the body 300 has a portion 30 which extends along the root portion 30 such that the first and second root surfaces and the first and second bonding surfaces extend beyond the tapered region, into a region where those surfaces are substantially parallel to one another.

An adhesive medium is located between the root surfaces and the bonding surfaces, in order to bond the body 300 to the root portion 30. The extension of the root and bonding surfaces to a parallel region of the root portion 30 serves to reduce the risk of the spar delaminating. The body 300 can also be secured to the root portion 30 using one or more optional bolts 305 in addition to the adhesive medium. The body 300 is provided with a threaded hole 303 for receiving a threaded stud (not shown), or other appropriate means, for attachment to a blade mounting.

One disadvantage of the structure of the second and third embodiments illustrated in FIGS. 7 and 8 respectively is that preparing the root and bonding surfaces is difficult, and not always reliable. This is because the V-shaped nature of the body 300, preparing the bonding surfaces 301 and 302 reliably is complex, particularly at the point at which the surfaces converge. The shape can lead to the adhesive medium being forced out of the body, and therefore out of contact with the bonding and root surfaces, when it is applied to the surfaces during manufacture.

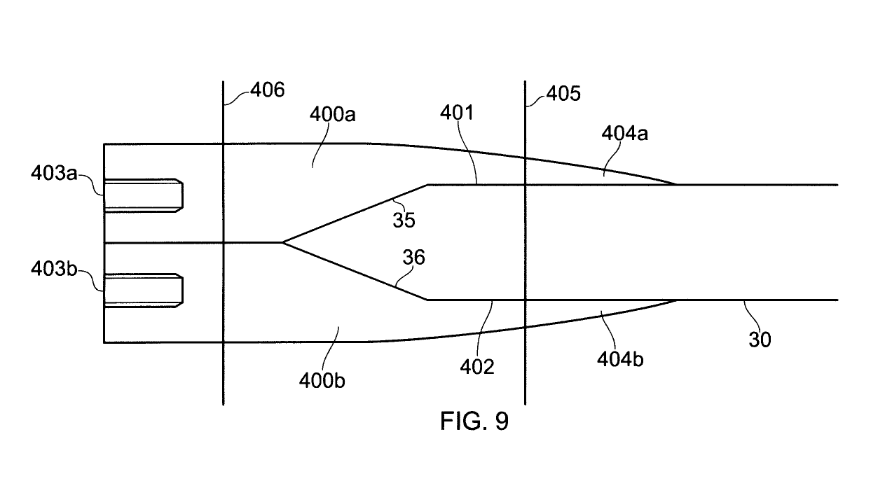

FIG. 9 illustrates a fourth embodiment of the present invention that improves on the third embodiment. In this fourth embodiment, the root portion 30 has first and second root surfaces 35 and 36 that converge to for a tapered free end. The root fitting of this embodiment comprises a two piece body, having a first body portion 400a and a second body portion 400b. The first body portion extends along one side of the root portion 30, and defines a first bonding surface 401 which is bonded to the first root surface 35 using a bonding medium. The first body portion extends 404a along the root portion 30 so as to overlap a region of the root portion in which the first and second root surfaces are substantially parallel to one another.

The second body portion extends along the other side of the root portion 30 to the first body portion 400a, and defines a second bonding surface 401 which is bonded to the second root surface 35 using a bonding medium. The second body portion extends 404b along the root portion 30 so as to overlap a region of the root portion in which the first and second root surfaces are substantially parallel to one another.

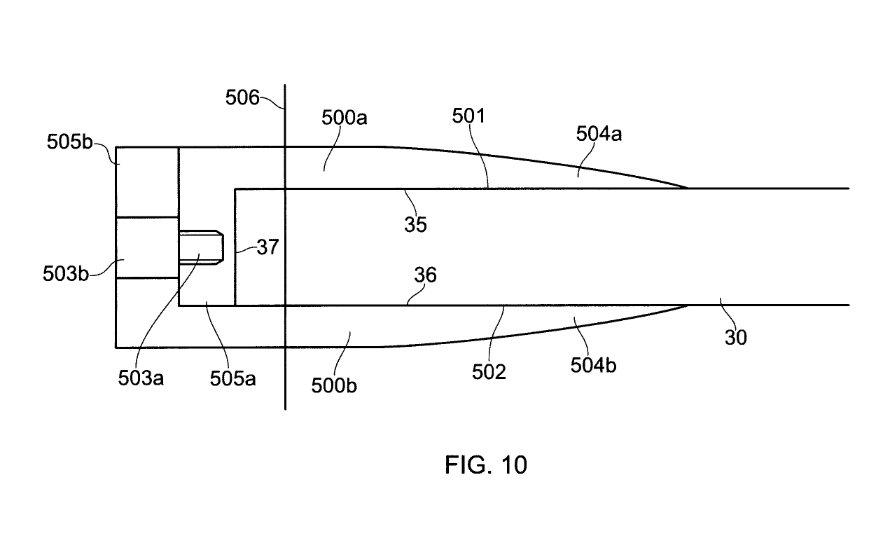

The first and second body portions 400a and 400b are provided with respective threaded holes 403a and 403b for receiving threaded studs for attachment to a blade mounting. As before, an appropriate alternative attachment means may be provided. The number of threaded holed provided can be varied according to the design of the blade mounting. The body portions 400a and 400b can be held in place using either or both optional bolts 405 and 406, which extend through both body portions so as to hold the portion together. The fourth embodiment illustrated in FIG. 9 enables the first bonding surface 401 to be bonded to the first root surface 35 separately from the bonding of the second bonding surface 402 to the second root surface 36. The body portions 400a and 400b can be bonded to the root portion 30 in any order. This separation of the bonding steps means that the surface preparation is a less complex operation and is also more reliable. The adhesive medium can be applied onto an “open” surface, which means that it is simple to coat the surface effectively. The body portions 400a and 400b can also be placed into contact with the root portion 30 in directions onto the root portion, rather than along the root portion 30, and so the adhesive medium can remain in contact with the surfaces 35, 36, 401 and 402. FIG. 10 illustrates a fifth embodiment of the present invention in which a root fitting is attached to a free end of the root portion 30. The free end of the root portion 30 has parallel first and second root surfaces 35 and 36. A third root surface 37 extends between the first and second root surfaces 35 and 36, and forms the end of the root portion 30.

The root fitting comprises first and second body portions 500a and 500b. The first body portion 500a extends from the end of the root portion 30 along the first root surface 35, and has a first bonding surface 501 that is bonded to the first root surface 35. This bond is achieved using an adhesive medium applied to one or both of the first root and bonding surfaces 35 and 501. The first body portion has an end region 504a that tapers in towards the root portion 30.

The first body portion 500a also includes an end part 505a which extends adjacent, and substantially parallel to, the third end surface of the root portion 30. This end part 505a has an outer surface, and a threaded hole 503a for receiving a threaded stud for attachment to a blade mounting.

The second body portion 500b extends along the second root surface 36 from the end of the root portion 30, and has a tapered end region 504b. The second body portion 500b defines a second bonding surface 502 which is bonded to the second root surface 36 by way of an adhesive medium. The second body portion 500b also includes an end part 505b which extends adjacent, and substantially parallel to, the outer surface of the end part 505a of the first body portion 500b. In this way, the end part 505b of the second body portion 500b can be seen to overlap the end part 505a of the first body portion 500a. The end part 505b of the second body portion 500b is provided with a through hole 503b that is coaxial with the threaded hole 503a of the end part 505a of the first body portion 500a, to allow a threaded stud to pass through, thereby enabling attachment with a blade mounting. As before, the threaded hole and stud arrangement may be replaced by any suitable means for attaching the fitting to the blade mounting.

It will be readily appreciated that the end parts 505a and 505b of the first and second body portions 500a and 500b could be reversed such that the end part 505b of the second body portion 500b is adjacent the third root surface 37, and is provided with a threaded hole. The first and second body portions 500a and 500b can also be secured to the root portion 30 using one or more optional bolts 506. The choice to use a plurality of bolts is dependent upon design criteria.

FIG. 11 illustrates a sixth embodiment of the present invention that comprises a two part fitting having first and second body portions 600. The structure of the fitting is similar to that shown in FIG. 10; first and second body portions 605a and 605b extend from the end of the root portion, and overlap at that end. The body portions are bonded to the root portion 30 using an adhesive medium applied between first and second root surfaces 35 and 36 and first and second bonding surfaces 601 and 602. Threaded and through holes 603a and 603b are provided in the end parts 605a and 605b of the first and second body portions 600a and 600b, as before, and could be replaced by any other suitable means for attachment to a blade mounting. In contrast to the embodiment shown in FIG. 10, the root portion 30 in this embodiment has root surfaces 35 and 36 that have portions that diverge towards the end of the root portion, so as to define an enlarged root portion end 38. The body portions 600a and 600b are shaped accordingly so that the first bonding surface is substantially parallel to the first root surface, and so that the second bonding surface is substantially parallel to the second root surface.

It will be readily appreciated that the end region of the root portion 30 can be of any appropriate shape, and that the body or body portions of the fitting can be adjusted to suit the shape of the root portion 30.

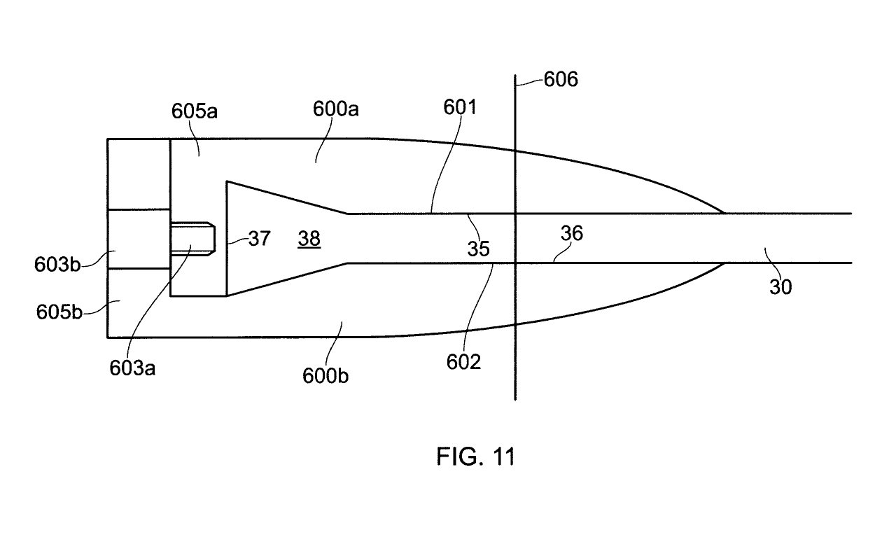

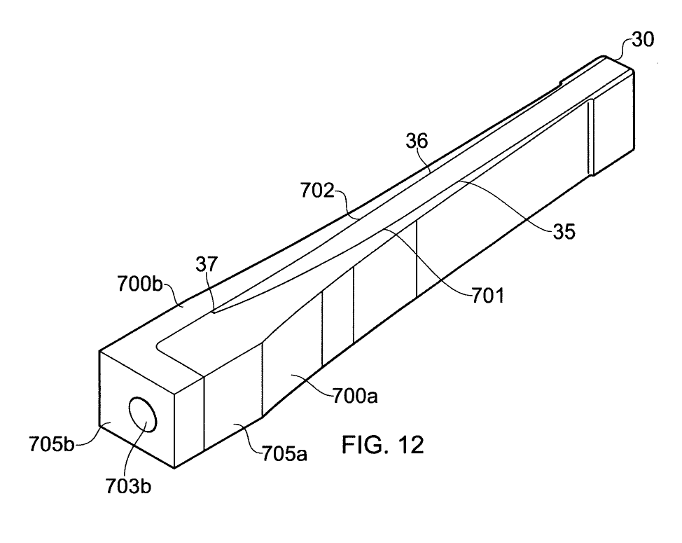

FIG. 12 illustrates another embodiment of the present invention, in which the root portion 30 defines root surfaces 35 and 36, which converge towards the free end of the root portion, to an end region 37, such that the root portion 30 tapers towards its free end. A two part fitting, comprising a first body portion 700a and a second body portion 700b, is arranged to attach the blade to the rotor. The first body portion 700a defines a first bonding surface 701 that is bonded to the first root surface 35 of the root portion 30, and the second body portion 700b defines a second bonding surface that is bonded to the second root surface 36 of the root portion 30. The first body portion 700a has an end region 705a from which the body portion extends, and tapers towards the blade. The end region 705a defines a threaded hole or holes (not shown) for receiving a threaded fixing arrangement for attachment to the rotor. The second body portion 700b extends along the root portion 30 to the opposite side from the first body portion 700b, and includes an end region 705b that extends around and overlaps the end region 705a of the first body portion 700a. The end region 705b of the second body portion 700b defines a through hole or through holes 703b, through which the fixing arrangement attached to the first body portion can pass.

As before, the threaded hole and stud arrangement may be replaced by any suitable means for attaching the fitting to the blade mounting. The first and second body portions 700a and 700b can also be secured to the root portion 30 using one or more optional bolts (not shown for the sake of clarity). The choice to use a plurality of bolts is dependent upon design criteria. In addition, or alternatively, one of more bolts can be used to secure together the end regions 705a and 705b.

The fitting of FIG. 12 can be attached to the root portion 30 of the blade as two parts that have “open” surfaces for receiving the bonding agent. This arrangement enables a reliable bond to be achieved, since the bonding agent can be evenly applied, and the part can be held in place relatively straightforwardly.

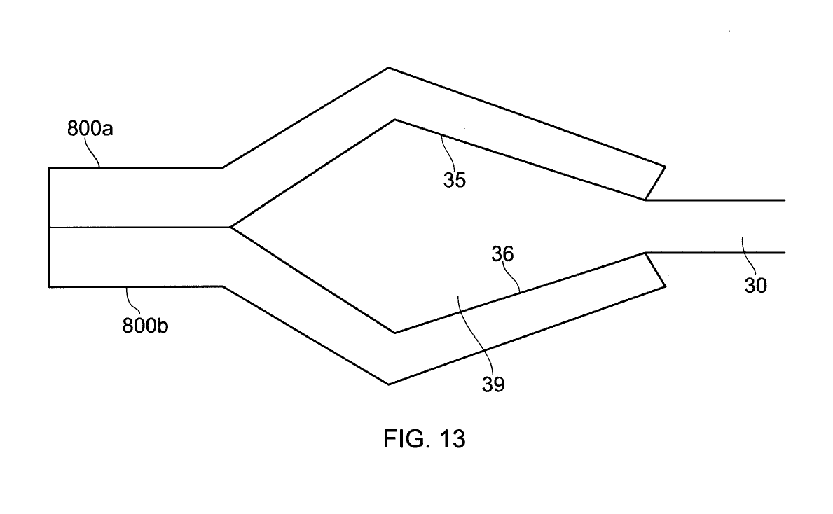

FIG. 13 illustrates another embodiment of the present invention, in which the root portion 30 defines root surfaces 35 and 36 which diverge and then converge in a direction towards the free end of the root portion 30. This construction is mirrored in the fitting which has a corresponding shape to provide bonding surfaces substantially parallel to the root surfaces 35 and 36. The fitting is a two part fitting, having body portions 910a and 910b, and can include the features and characteristics of the earlier described embodiments.

FIG. 14 illustrates another embodiment of the present invention which makes use of a two part fitting. In the FIG. 14 example, the root portion 30 of the blade defines first and second root surfaces 35 and 36 that converge towards the free end of the root portion 30, so that the root portion tapers. The fitting comprises first and second body portion 900a and 900b, which define first and second bonding surfaces 901 and 902 respectively. The first and second bonding surfaces 901 and 902 are bonded with the first and second root surfaces 35 and 36 respectively. The first body portion 900a has an end region 905a, from which the body portion 900a extends, tapering along the root portion 30 towards the blade. Similarly, the second body portion 900b has and end region 905b, from which that body portion 900b extends, tapering along the root portion 30 towards the blade.

The end regions 905a and 905b engage with one another along an inner surface, which in this example is along the centre line of the fitting, but which can be arranged as appropriate. The end regions are held in contact with one another by way of a number of bolts 906. The number of bolts shown in FIG. 14 is exemplary only, and any number of bolts could be used. The fitting of FIG. 14 can be attached to the root portion 30 of the blade as two parts that have “open” surfaces for receiving the bonding agent, as for the other two part fittings described above. This arrangement enables a reliable bond to be achieved, since the bonding agent can be evenly applied, and the part can be held in place relatively straightforwardly.

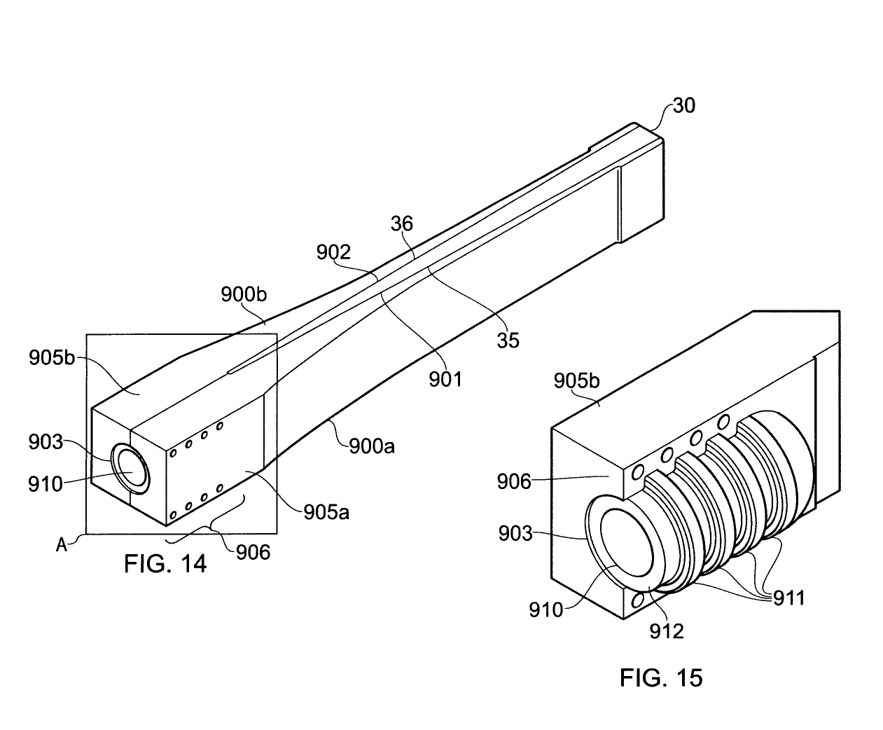

The embodiment of FIG. 14 also includes a threaded component 910, which is shown in more detail in FIG. 15. FIG. 15 highlights details from box A of FIG. 14. The threaded component 910 is cylindrical in nature, and is located in correspondingly shaped cavities in the first and second body portions 900a and 900b. The threaded component 910 has a cylindrical body 912, an inner surface of which is threaded for reception and retention of a threaded fixing arrangement for attaching the fitting to the rotor. A number of raised ridge features 911 are defined on an outer surface of the cylindrical body 912, and engage with corresponding features in the first and second body portions 900a and 900b. The number of raised ridge features is arbitrary and to be decided by design requirements. In addition to being retained by the ridge feature 911, the threaded fitting 910 may be bonded to one or both of the end regions 905a and 905b of the first and second body portions 900a and 900b. The threaded component 910 is preferably a cast metallic part, but can be of any suitable material.

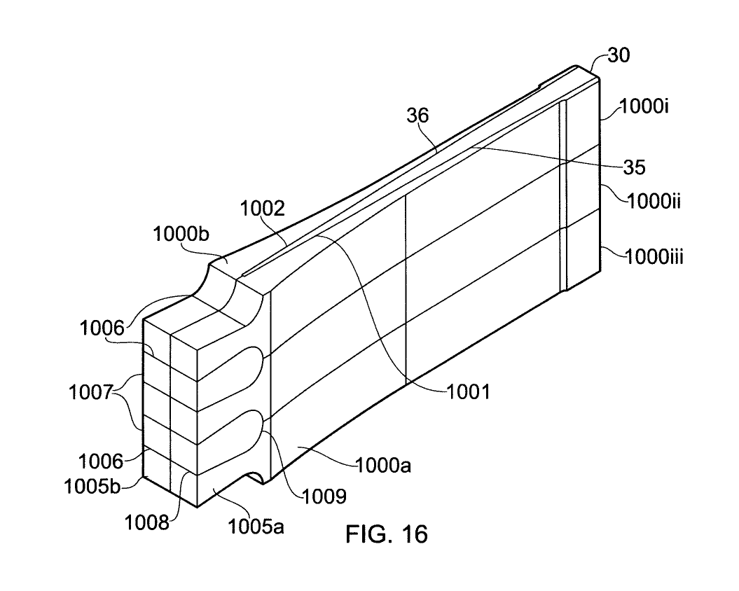

FIG. 16 illustrates another embodiment of the present invention which makes use of a two part fitting. In FIG. 16, three identical fittings 1000i, 1000ii and 1000iii are illustrated. The fittings are arranged around the root portion of the blade, and only a part of the overall fitting is shown in FIG. 16. The description below applies to each of the fittings shown in FIG. 16; the reference numerals have been used sparingly, however, for the sake of clarity of the drawing.

In the FIG. 16 example, the root portion 30 of the blade defines first and second root surfaces 35 and 36 that converge towards the free end of the root portion 30, so that the root portion tapers. The fitting comprises first and second body portion 1000a and 1000b, which define first and second bonding surfaces 1001 and 1002 respectively. The first and second bonding surfaces 1001 and 1002 are bonded with the first and second root surfaces 35 and 36 respectively. The first body portion 1000a has an end region 1005a, from which the body portion 1000a extends, tapering along the root portion 30 towards the blade. Similarly, the second body portion 1000b has and end region 1005b, from which that body portion 1000b extends, tapering along the root portion 30 towards the blade.

The end regions 1005a and 1005b engage with one another along an inner surface, which in this example is along the centre line of the fitting, but which can be arranged as appropriate. The fitting of FIG. 16 can be attached to the root portion 30 of the blade as two parts that have “open” surfaces for receiving the bonding agent, as for the other two part fittings described above. This arrangement enables a reliable bond to be achieved, since the bonding agent can be evenly applied, and the part can be held in place relatively straightforwardly.

The end regions 1005a and 1005b define a receiving feature 1006 on each of two radial surfaces of the regions. The radial surface is the surface of the end region which is positioned adjacent the next fitting in the series around the root portion of the blade. The receiving features 1006 of neighbouring fittings combine to define an aperture which receives a connection part 1007. The aperture and connection part 1007 have complementary engaging shapes, and increase in width in a direction towards the blade, away from the rotor. In this way the connection part 1007 is held in place between the receiving features of the neighbouring body portions of the fitting. The connection part 1007 may also be bonded in place.

The connection part 1007 is preferably a cast metallic part, but could be of any other suitable material. The connection part 1007 defines at least one threaded hole (not shown) for reception of a fixing arrangement for attachment to the rotor.

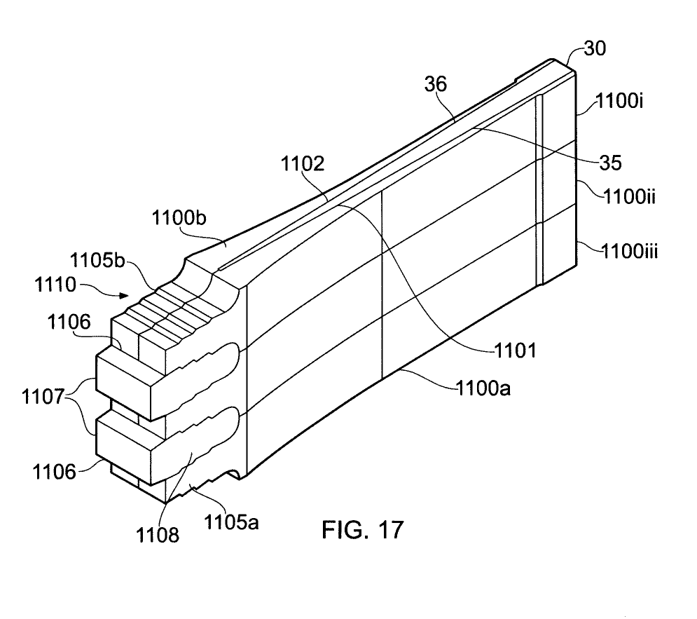

FIG. 17 illustrates another embodiment of the present invention which makes use of a two part fitting. In FIG. 17, as in FIG. 16, three identical fittings 1100i, 1100ii and 1100iii are illustrated. The fittings are arranged around the root portion of the blade, and only a part of the overall fitting is shown in FIG. 17. The description below applies to each of the fittings shown in FIG. 17; the reference numerals have been used sparingly, however, for the sake of clarity of the drawing.

In the FIG. 17 example, the root portion 30 of the blade defines first and second root surfaces 35 and 36 that converge towards the free end of the root portion 30, so that the root portion tapers. The fitting comprises first and second body portion 1100a and 1100b, which define first and second bonding surfaces 1101 and 1102 respectively. The first and second bonding surfaces 1101 and 1102 are bonded with the first and second root surfaces 35 and 36 respectively. The first body portion 1100a has an end region 1105a, from which the body portion 1100a extends, tapering along the root portion 30 towards the blade. Similarly, the second body portion 1100b has and end region 1105b, from which that body portion 1100b extends, tapering along the root portion 30 towards the blade.

The end regions 1105a and 1105b engage with one another along an inner surface, which in this example is along the centre line of the fitting, but which can be arranged as appropriate. The fitting of FIG. 17 can be attached to the root portion 30 of the blade as two parts that have “open” surfaces for receiving the bonding agent, as for the other two part fittings described above. This arrangement enables a reliable bond to be achieved, since the bonding agent can be evenly applied, and the part can be held in place relatively straightforwardly.

The end regions 1105a and 1105b define a receiving feature 1106 on each of two radial surfaces of the regions. The radial surface is the surface of the end region which is positioned adjacent the next fitting in the series around the root portion of the blade. The receiving features 1106 of neighbouring fittings combine to define an aperture which receives a connection part 1107. In the FIG. 17 example, the receiving feature 1106 has a stepped profile, and the connection part 1107 has a complementary shape to engage with the stepped profile of the feature 1106. In this way the connection part 1107 is held in place between the receiving features 1106 of the neighbouring body portions of the fitting. The connection part 1107 may also be bonded in place.

The connection part 1107 is preferably a cast metallic part, but could be of any other suitable material. The connection part 1107 defines at least one threaded hole (not shown) for reception of a fixing arrangement for attachment to the rotor.

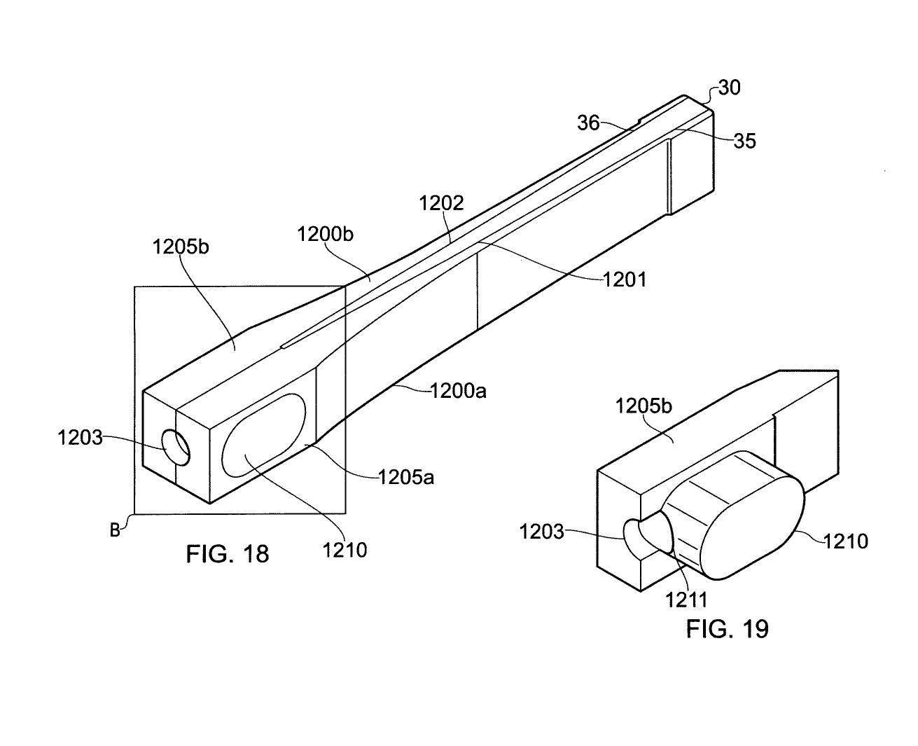

FIG. 18 illustrates another embodiment of the present invention which makes use of a two part fitting. In the FIG. 18 example, the root portion 30 of the blade defines first and second root surfaces 35 and 36 that converge towards the free end of the root portion 30, so that the root portion tapers. The fitting comprises first and second body portion 1200a and 1200b, which define first and second bonding surfaces 1201 and 1202 respectively. The first and second bonding surfaces 1201 and 1202 are bonded with the first and second root surfaces 35 and 36 respectively. The first body portion 1200a has an end region 1205a, from which the body portion 1200a extends, tapering along the root portion 30 towards the blade. Similarly, the second body portion 1200b has and end region 1205b, from which that body portion 1200b extends, tapering along the root portion 30 towards the blade.

The end regions 1205a and 1205b engage with one another along an inner surface, which in this example is along the centre line of the fitting, but which can be arranged as appropriate. The end regions may held in contact with one another by way of a number of bolts (not shown). The fitting of FIG. 18 can be attached to the root portion 30 of the blade as two parts that have “open” surfaces for receiving the bonding agent, as for the other two part fittings described above. This arrangement enables a reliable bond to be achieved, since the bonding agent can be evenly applied, and the part can be held in place relatively straightforwardly.

The embodiment of FIG. 18 also includes a threaded component 1210, which is shown in more detail in FIG. 19. FIG. 19 highlights details from box B of FIG. 18. The threaded component 1210 defines at least one threaded hole 1211 for reception of a fixing arrangement for attachment to the rotor. The end regions 1205a and 1205b of the body portions 1200a and 1200b define apertures therethrough for reception of the threaded component 1210. In the example shown in FIGS. 18 and 19, the threaded component extends radially with respect to the root portion of the blade, and has a constant cross section; in this case a lozenge shaped cross section. The apertures defined in the end regions 1205a and 1205b correspond to the cross section of the threaded component 1210 such that it is held in place between the first and second body portions 1200a and 1200b. In addition, the apertures in the end regions extend completely through the end regions. The threaded component can have any appropriate cross section, and may be bonded in place in the end regions 1205a and 1205b.

The end regions 1205a and 1205b also define a through hole 1203 through which the fixing arrangement may pass.

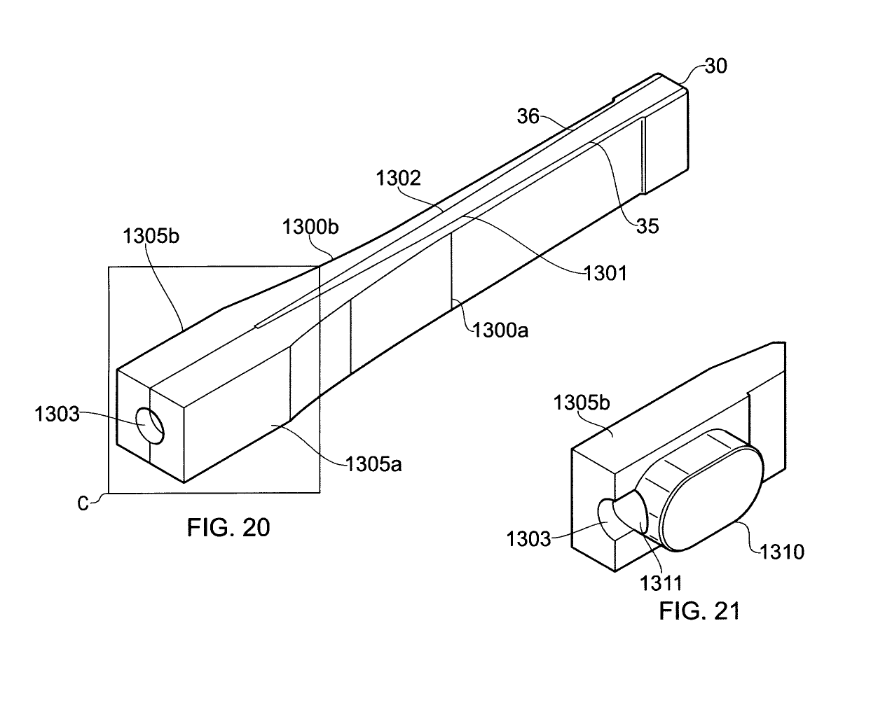

FIGS. 20 and 21 illustrate a further embodiment of the invention which is similar in construction to that shown in FIGS. 18 and 19. FIG. 21 highlights details from box C of FIG. 20. The FIGS. 20 and 21 embodiment has a pair of body portions 1300a and 1300b, having respective end regions 1305a and 1305b which define apertures for reception and retention of a threaded component 1310. As in FIGS. 18 and 19, the embodiment shown in FIGS. 20 and 21 makes use of a threaded component having a constant lozenge shaped cross section. The cross section can be any suitable shape. The threaded component 1310 extends radially with respect to the root portion of the blade. In contrast to the previous embodiment, the apertures defined by the end regions 1305a and 1305b do not extend completely through the end regions. One other possibility is for one of the end regions to have apertures that extend completely therethrough, and for the other body portion to have an aperture that does not.

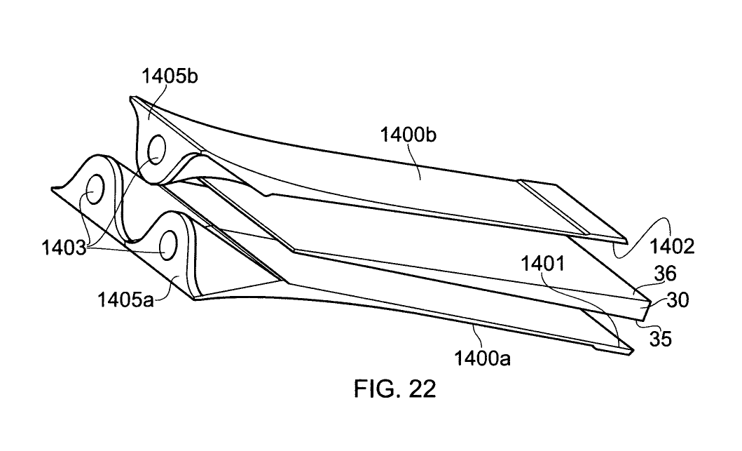

FIG. 22 illustrates another embodiment of the present invention which makes use of a two part fitting. In the FIG. 22 example, the root portion 30 of the blade defines first and second root surfaces 35 and 36 that converge towards the free end of the root portion 30, so that the root portion tapers. The fitting comprises first and second body portion 1400a and 1200b, which define first and second bonding surfaces 1401 and 1402 respectively. The first and second bonding surfaces 1401 and 1402 are bonded with the first and second root surfaces 35 and 36 respectively. The first body portion 1400a has an end region 1405a, from which the body portion 1400a extends. Similarly, the second body portion 1400b has and end region 1405b, from which that body portion 1400b extends.

The fitting of FIG. 22 can be attached to the root portion 30 of the blade as two parts that have “open” surfaces for receiving the bonding agent, as for the other two part fittings described above. This arrangement enables a reliable bond to be achieved, since the bonding agent can be evenly applied, and the part can be held in place relatively straightforwardly.

The end regions 1405a and 1405b have complementary engaging shapes, in the case of FIG. 22, complementary curved shapes: the first end region 1305a has pair of protruding curved portions that define a corresponding curved aperture therebetween. The second end region 1405b has similar protruding curved portion which engages with the curved aperture of the first end region 1405a. When in place on the root portion of a blade, a series of the first body portions form a series of such curved apertures for reception of a series of the second body portions.

In an alternative example, the end region of the second body portion 1400b may also have a pair of protruding curved portions. In that case, a second body portion 1400b would engage with two neighbouring first body portions, to provide an interlocked serried of fittings.

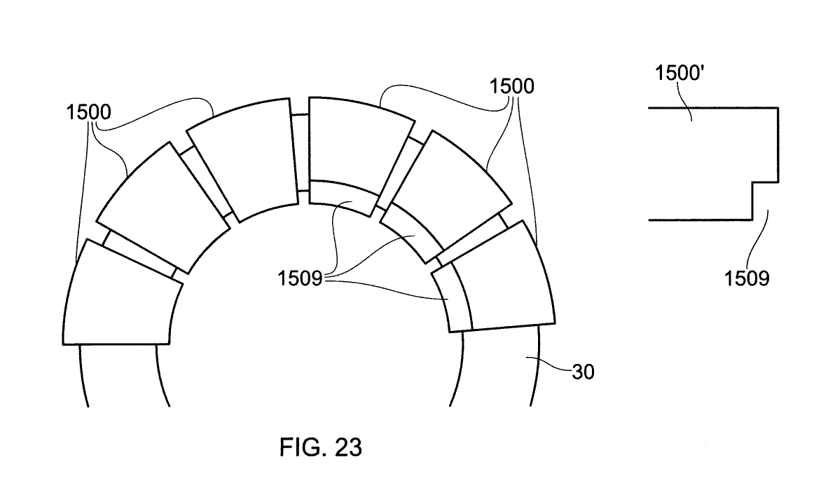

FIG. 23 shows an end view of a plurality of root fittings 1500 in place on a root portion 30. The cross section of each of the root fittings shown in FIG. 23 is sector shaped, so that the fittings fit around the annular root portion 30 of the blade. This sector shaped cross section is applicable to any of the embodiments of the invention described above. As an alternative, the fitting may have a square or rectangular cross section. FIG. 23 also illustrates another feature that is applicable to any of the embodiments described. This additional feature is a locating surface 1509 provided on one or more of the fittings 1500′ to engage with a complementary feature on the blade mounting, in order to ensure correct alignment of the blade.

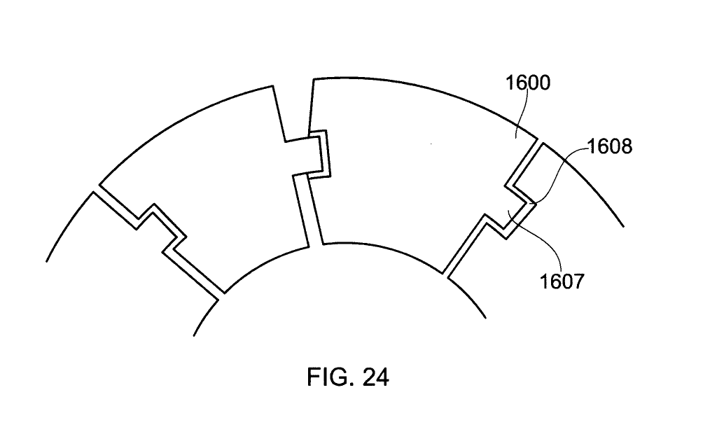

FIG. 24 illustrates an additional feature that is applicable to any of the embodiments of the present invention described above. The body (or one or both of the body portions in the case of the two part fitting) is provided with means for interlocking with adjacent fittings. The fittings 1600 are arranged around the end of the root portion 30 in a series, and each fitting is interlocked with the next fitting in the series. FIG. 24 illustrates one possible way to achieve interlocking, which is to provide the fitting 1600 with an interlocking portion 1607 with extends out from the fitting 1600 towards the next fitting in the series, and interlocks with a corresponding recess 1608 in the next fitting 1600. By interlocking the fittings, it is possible to increase the loads that can be carried by a given size of fitting.

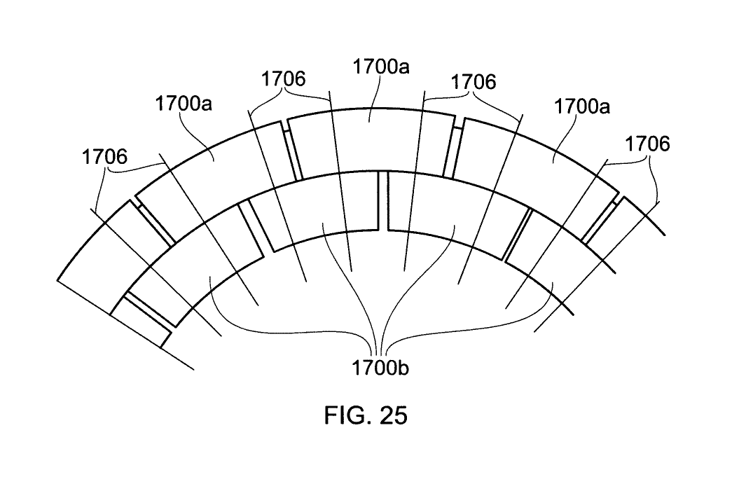

FIG. 25 is a cross sectional end view illustrating a technique for interlocking the two part embodiments described above. The first body portions 1700a are arranged around the outer surface of the annular root portion 30 in a series, as before. The second body portions 1700b are arranged in a series around the inner surface of the root portion 30. The second body portions 1700b are offset with respect to the first body portions 1700a, such that any one of the second body portions 1700b overlaps, and is attached to, two of the first body portions 1700a. The first and second body portions may be attached to one another by the use of an appropriate number of bolts 1706. Threaded holes for receiving threaded studs can be provided in appropriate positions in the first and/or second body portions 1700a and 1700b. This overlapping interlocking serves to improve the strength of the root fitting as a whole.

The first and second root surfaces and/or the first and second bonding surfaces can be smooth, or unfinished. Alternatively, the first and second root surfaces and/or the first and second bonding surfaces can be finished in order to increase the bonding strength of the adhesive medium. For example, the surfaces may be provided with a high roughness surface treatment, or may be grooved or serrated.

It will be readily appreciated that the references above to first and second body portions is made for the sake of clarity, and that the body portions can be arranged with the first portion either inside or outside the root portion of the blade, with the second body portion in the corresponding opposite position.

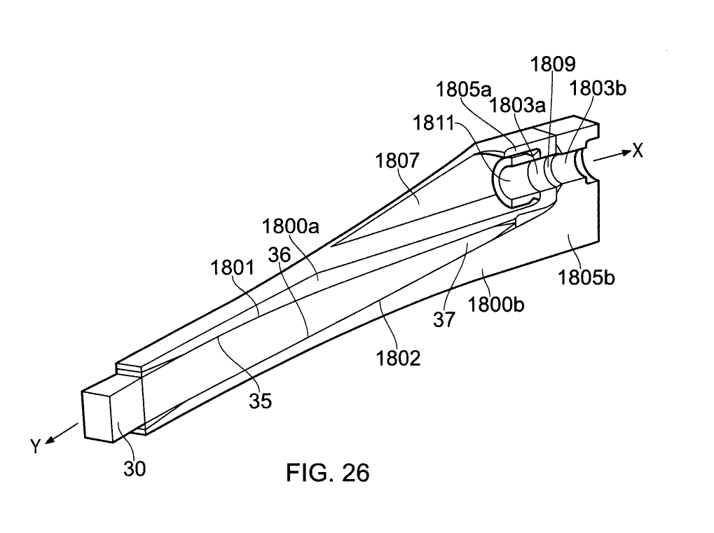

FIG. 26 illustrates a cross sectional view of another embodiment of the present invention, in which the root portion 30 defines root surfaces 35 and 36, which converge towards the free end of the root portion, to an end region 37, such that the root portion 30 tapers towards its free end. A two part fitting, comprising a first body portion 1800a and a second body portion 1800b, is arranged to attach the blade to the rotor. The first body portion 1800a defines a first bonding surface 1801 that is bonded to the first root surface 35 of the root portion 30, and the second body portion 1800b defines a second bonding surface 1802 that is bonded to the second root surface 36 of the root portion 30. The first body portion 1800a has an end region 1805a from which the body portion extends, and tapers towards the blade. The end region 1805a defines a hole for receiving a fixing arrangement for attachment to the rotor, as will be described in more detail below. The second body portion 1800b extends along the root portion 30 to the opposite side from the first body portion 1800b, and includes an end region 1805b that extends around and overlaps the end region 1805a of the first body portion 1800a. The end region 1805b of the second body portion 1800b defines a through hole 1803b, through which the fixing arrangement can pass. As described with reference to other embodiments, the root portion 30 may also be bolted to the root fitting using any number of suitable bolts that extend through the first and second body portions 1800a and 1800b of the root fitting, and through the root portion 30.

The fitting of FIG. 26, in similar manner to the embodiment of FIG. 12, can be attached to the root portion 30 of the blade as two parts that have “open” surfaces for receiving the bonding agent. This arrangement enables a reliable bond to be achieved, since the bonding agent can be evenly applied, and the part can be held in place relatively straightforwardly. In the FIG. 26 embodiment, the root fitting is attached to the rotor using a bolt that passes through the holes 1803a and 1803 of the root body portions 1800a and 1800b, in a direction indicated by the arrow X in the Figure. Such a bolt has a threaded end that locates in a threaded hole defined in the rotor, and so this arrangement allows the blade to be attached to the rotor from a position external to the rotor housing. The fixing bolt has a head which is accessible from the blade side of the root fitting, thereby enabling a tool to be used externally of the rotor housing to tighten the fixing arrangement. Such a configuration enables more straightforward fitting and removal of the blade from the rotor.

In order that the bolt head is accessible externally, the direction X in which the bolt is inserted diverges from the direction in which the root portion extends from the root fitting (as indicated by the arrow Y in FIG. 26). In addition at least one strengthening rib 1807 is provided in order to provide the fitting with the required stiffness and strength. In order to enable the fitting and bolt arrangement to align appropriately, a self aligning washer 1809 can be provided at the interface of the body portions 1800a and 1800b in line with the holes 1803a and 1803b. The washer 1809 can be spherical washer.

A compression tube 1811 can also be provided in the hole 1803a of the first body portion 1800a, so that the bolt passing therethrough can be tensioned to the correct level.

As an alternative to the bolts passing through the holes 1803a and 1803b into the rotor hub, studs that project from the rotor hub can be arranged to extend through the holes. The studs then have threaded end portions that emerge from the root fitting to enable fixing nuts to be attached to the studs. The nuts can be tightened from a position external to the rotor housing. It will be appreciated that any suitable fixing arrangement can be used to attach the root fitting to the rotor hub, such an arrangement utilising the external access feature described above.

1. A rotor blade comprising:
a blade portion;
a root portion connected with, and extending from, the blade portion, the root portion defining first and second root surfaces, the first root surface being an outer surface of the root portion, and the second root surface being an inner surface of the root portion that bounds an interior volume thereof; and
a plurality of discrete root fittings connected with respective parts of the root portion of the blade, each root fitting comprising an attachment portion adapted for attachment to a blade mounting, and an elongate body member defining first and second bonding surfaces, which elongate body member extends from a free end of the root portion towards the blade portion, such that the first bonding surface extends adjacent the first surface of the root portion, and such that the second bonding surface extends adjacent the second root surface of the root portion, the first and second bonding surfaces being adhesively bonded to the first and second root surfaces respectively.

2. A rotor blade as claimed in claim 1, wherein the first and second root surfaces of at least one root fitting are substantially parallel to one another.

3. A rotor blade as claimed in claim 1, wherein portions of the first and second root surfaces converge towards the end of the root portion.

4. A rotor blade as claimed in claim 1, wherein the first bonding surface of at least one root fitting is substantially parallel to the first root surface and the second bonding surface of at least one root fitting is substantially parallel to the second root surface.

5. A rotor blade as claimed in claim 1, wherein portions of the first and second root surfaces diverge towards an end region of the root portion.

6. A rotor blade as claimed in claim 1, wherein at least one root fitting is bolted to the root portion of the blade.

7. A rotor blade as claimed in claim 1, wherein at least one root fitting is bolted to the root portion of the blade, and wherein at least one root fitting further comprises a bolt which extends through the body portion of that root fitting and through a corresponding part of the root portion of the blade.

8. A rotor blade as claimed in claim 1, wherein the first and second root surfaces and the first and second bonding surfaces are substantially smooth.

9. A rotor blade as claimed in claim 1, wherein at least one of the first and second root surfaces and the first and second bonding surfaces are treated to increase bonding strength of an adhesive bonding medium.

10. A rotor blade as claimed in claim 1, wherein the root fittings are arranged as a series around the root portion of the blade, each root fitting being interlocked with the next root fitting in the series.

11. A rotor blade as claimed in claim 1, wherein the elongate body member of at least one of the root fittings comprises separate first and second body portions which define the first and second bonding surfaces respectively.

12. A rotor blade as claimed in claim 1, wherein the elongate body member of at least one of the root fittings comprises separate first and second body portions which define the first and second bonding surfaces respectively, and wherein the root portion has a third root surface which extends between the first and second root surfaces, wherein the first body portion includes an end part which has an inner surface extending substantially parallel to, and adjacent, the third surface, and an outer surface, and wherein the second body portion includes an end part which has an inner end surface extending parallel to, and adjacent, the outer surface of the first body portion.

13. A rotor blade as claimed in claim 1, wherein the elongate body member of at least one of the root fittings comprises separate first and second body portions which define the first and second bonding surfaces respectively, and wherein the root portion has a third root surface which extends between the first and second root surfaces, wherein the first body portion includes an end part which has an inner surface extending substantially parallel to, and adjacent, the third surface, and an outer surface, and wherein the second body portion includes an end part which has an inner end surface extending parallel to, and adjacent, the outer surface of the first body portion, and wherein the end part of the first body portion defines a threaded hole for reception of a threaded stud therein, the threaded hole having an axis extending away from the root portion, and wherein the end part of the second body portion defines a hole coaxial with the threaded hole, such that a threaded stud received in the threaded hole extends from the end part of the first body portion, through the end part of the second body portion, in a direction away from the root portion of the blade.

14. A rotor blade as claimed in claim 1, wherein the elongate body member of at least one of the root fittings comprises separate first and second body portions which define the first and second bonding surfaces respectively, and wherein the root portion has a third root surface which extends between the first and second root surfaces, wherein the first body portion includes an end part which has an inner surface extending substantially parallel to, and adjacent, the third surface, and an outer surface, and wherein the second body portion includes an end part which has an inner end surface extending parallel to, and adjacent, the outer surface of the first body portion, and wherein the end part of the first body portion defines a hole having an axis extending away from the root portion, and wherein the end part of the second body portion defines a hole coaxial with the hole through the first body portion, thereby allowing a fixing arrangement to extend through the first and second body portions of the elongate body member.

15. A rotor blade as claimed in claim 1, wherein the elongate body member of at least one of the root fittings comprises separate first and second body portions which define the first and second bonding surfaces respectively, further comprising a threaded component located between respective end regions of the first and second body portions.

16. A rotor blade as claimed in claim 1, wherein the elongate body member of at least one of the root fittings comprises separate first and second body portions which define the first and second bonding surfaces respectively, and wherein the first and second body portions have respective end regions, each end region defining at least one receiving feature, and wherein the root fittings are arranged around the root portion of the blade to form a series, such that receiving features of neighbouring root fittings define at least one attachment aperture, the blade further comprising a plurality of fixing components located in respective attachment apertures, the fixing components having features for enabling attachment of the blade to a rotor.

17. A rotor blade as claimed in claim 11, wherein the elongate body member of at least one of the root fittings comprises separate first and second body portions which define the first and second bonding surfaces respectively, and wherein the first and second body portions have respective end regions, which define a receiving aperture therebetween, and wherein the blade comprises a plurality of attachment components, located in respective receiving apertures.

18. A rotor blade as claimed in claim 1, wherein the elongate body member of at least one of the root fittings comprises separate first and second body portions which define the first and second bonding surfaces respectively, and wherein the first and second body portions have respective end regions which interengage with one another.

19. A rotor blade as claimed in claim 1, wherein the root fittings are arranged as a series around the root portion of the blade, each root fitting being interlocked with the next root fitting in the series, and the root fittings are arranged as a series around the root portion of the blade, each root fitting being interlocked with the next root fitting in the series.

20. A rotor blade as claimed in claim 1, wherein the root fittings are arranged as a series around the root portion of the blade, each root fitting being interlocked with the next root fitting in the series, and the root fittings are arranged as a series around the root portion of the blade, each root fitting being interlocked with the next root fitting in the series, and wherein the second body portion of each root fitting is attached to the first body portion of that fitting, and to the first body portion of the next root fitting in the series.

21. A root fitting apparatus for attaching a rotor blade to a blade mounting, which rotor blade comprises a blade portion, a root portion connected with, and extending from, the blade portion, the root portion defining first and second root surfaces, the first root surface being an outer surface of the root portion, and the second root surface being an inner surface of the root portion that bounds an interior volume thereof, the root fitting apparatus comprising:
a plurality of discrete root fittings adapted for connection with respective parts of the root portion of the rotor blade, and comprising:
an attachment portion for attachment to a blade mounting; and
an elongate body member defining first and second bonding surfaces, which elongate body member extends from a free end region thereof towards a blade end region thereof, the first bonding surface extending along the elongate body substantially facing the second bonding surface, the bonding surfaces being adapted for adhesive bonding to respective root surfaces of a rotor blade.

22. A root fitting apparatus as claimed in claim 21, wherein the first and second bonding surfaces are substantially parallel to one another.

23. A root fitting apparatus as claimed in claim 21, wherein portions of the first and second bonding surfaces converge towards the free end region.

24. A root fitting apparatus as claimed in claim 21, wherein portions of the first and second bonding surfaces diverge towards the free end region.

25. A root fitting apparatus as claimed in any one claim 21, wherein each root fitting is adapted to be bolted to the root portion of the blade.

26. A root fitting apparatus as claimed in claim 21, wherein the first and second bonding surfaces are substantially smooth.

27. A root fitting apparatus as claimed in claim 21, wherein at least one of the first and second bonding surfaces is treated to increase bonding strength of an adhesive bonding medium.

28. A root fitting apparatus as claimed in claim 21, wherein the body member comprises separate first and second body portions which define the first and second bonding surfaces respectively.

29. A root fitting apparatus as claimed in claim 21, wherein the body member comprises separate first and second body portions which define the first and second bonding surfaces respectively, and wherein the first body portion includes an end part which has an inner surface, and an outer surface, and wherein the second body portion includes an end part which has an inner end surface extending parallel to, and adjacent, the outer surface of the first body portion.

30. A root fitting apparatus as claimed in claim 21, wherein the body member comprises separate first and second body portions which define the first and second bonding surfaces respectively, and wherein the first body portion includes an end part which has an inner surface, and an outer surface, and wherein the second body portion includes an end part which has an inner end surface extending parallel to, and adjacent, the outer surface of the first body portion, and wherein the end part of the first body portion defines a threaded hole for reception of a threaded stud therein, the threaded hole having an axis extending away from the root portion, and wherein the end part of the second body portion defines a hole coaxial with the threaded hole, such that a threaded stud received in the threaded hole extends from the end part of the first body portion, through the end part of the second body portion, in a direction away from the root portion of the blade.

31. A root fitting apparatus as claimed in claim 21, wherein the body member comprises separate first and second body portions which define the first and second bonding surfaces respectively, the rotor blade further comprising a threaded component located between respective end regions of the first and second body portions.

32. A root fitting apparatus as claimed in claim 21, wherein the body member comprises separate first and second body portions which define the first and second bonding surfaces respectively, and wherein the first and second body portions have respective end regions, each end region defining at least one receiving feature, such that when the root fittings are arranged around the root portion of the blade to form a series, receiving features of neighbouring root fittings define at least one attachment aperture in which a fixing component is located, the fixing components having features for enabling attachment of the blade to a rotor.

33. A root fitting apparatus as claimed in claim 21, wherein the body member comprises separate first and second body portions which define the first and second bonding surfaces respectively, and wherein the first and second body portions have respective end regions, which define a receiving aperture therebetween, in which aperture an attachment component is located.

34. A root fitting apparatus as claimed in claim 21, wherein the body member comprises separate first and second body portions which define the first and second bonding surfaces respectively, and wherein the first and second body portions have respective end regions which interengage with one another.

35. A root fitting apparatus as claimed in claim 21, adapted for use with a rotor blade, the rotor blade comprising:
a blade portion;
a root portion connected with, and extending from, the blade portion, the root portion defining first and second root surfaces, the first root surface being an outer surface of the root portion, and the second root surface being an inner surface of the root portion that bounds an interior volume thereof; and
a plurality of discrete root fittings connected with respective parts of the root portion of the blade, each root fitting comprising an attachment portion adapted for attachment to a blade mounting, and an elongate body member defining first and second bonding surfaces, which elongate body member extends from a free end of the root portion towards the blade portion, such that the first bonding surface extends adjacent the first surface of the root portion, and such that the second bonding surface extends adjacent the second root surface of the root portion, the first and second bonding surfaces being adhesively bonded to the first and second root surfaces respectively.
